(19) United States
(12) Patent Application Publication
(10) Pub. No.: US 2012/0231673 A1
(43) Pub. Date: Sep. 13, 2012

(54) RECEPTACLE CONNECTOR AND PLUG CONNECTOR TO BE FITTED TO THE RECEPTACLE CONNECTOR

(76) Inventors: Koji HAYASHI, Kanagawa-ken (JP); Nobukazu KATO, Kanagawa-ken (JP)

(21) Appl. No.: 13/415,226

(22) Filed: Mar. 8, 2012

(30) Foreign Application Priority Data
Mar. 9, 2011 (JP) P2011-051940

(51) Int. Cl. H01R 24/58

(52) U.S. Cl. 439/675

(57) ABSTRACT

A receptacle connector includes: a connector body in which five of long plate-like parallel terminals are embedded in a parallel terminal embedding portion in a state of individually exposing one surface sides thereof; a counterpart connector insertion hood that covers an outer circumference of the connector body and allows a counterpart connector to be inserted thereinto; an extension terminal embedding portion provided on at least one of a pair side portions of the connector body in a parallelly arrayed direction of the parallel terminals; and an extension terminal embedded in the extension terminal embedding portion in a state of being exposed toward the parallelly arrayed direction.

### BACKGROUND OF THE INVENTION

1. Field of the Invention

The present invention relates to a receptacle connector based on the Micro-USB standard, and to a plug connector to be fitted to the receptacle connector.

2. Description of the Related Art

USB connectors are used for connecting a computer and peripheral instruments (a keyboard, a printer, a modem, and the like) of the computer to each other. In accordance with the USB connectors, it takes a long time to transmit a large-capacity signal between the computer and such a peripheral instrument, or to transmit the large-capacity signal between these instruments.

Meanwhile, it is desired that the USB connectors be miniaturized since it is necessary to reduce a space to be occupied by the USB connectors, for example, in the case where the USB connectors concerned are mounted on an instrument such as a notebook computer.

In this connection, the standard of the Micro-USB connector that has a larger number of terminals and is smaller than such a USB connector is established (Universal Serial Bus Micro-USB Cables and Connectors Specification, Revision 1.01, Apr. 4, 2007), and Micro-USB connectors which are based on this standard are mounted on a large number of instruments. Such a Micro-USB connector is smaller but has a larger number of terminals than the USB connector, and accordingly, can rapidly transmit the large-capacity signal.

### SUMMARY OF THE INVENTION

In recent years, for example, in a video signal or the like, a capacity of the signal to be transmitted has been increased in order to enhance resolution thereof, and a transmission amount of the signal has been increased. Therefore, it has been desired that a larger-capacity signal be rapidly transmitted. For the purpose of rapidly transmitting the large-capacity signal, it is conceived to increase the number of terminals of the Micro-USB connector. However, since a shape, dimension and the like of the Micro-USB connector are defined by the Micro-USB standard, the number of terminals cannot be simply increased.

In this connection, it is an object of the present invention to provide a receptacle connector, which, without changing the size of the Micro-USB connector, has fitting compatibility with a counterpart connector that is based on the Micro-USB standard, and can rapidly transmit the large-capacity signal, and to provide a plug connector to be fitted to this receptacle connector.

A receptacle connector according to a first aspect of the present invention includes: a connector body in which five of long plate-like parallel terminals are embedded in a parallel terminal embedding portion in a state of individually exposing one surface sides thereof; a counterpart connector insertion hood that covers an outer circumference of the connector body and allows a counterpart connector to be inserted thereinto; an extension terminal embedding portion provided on at least one of a pair of side portions of the connector body in a parallelly arrayed direction of the parallel terminals; and an extension terminal embedded in the extension terminal embedding portion in a state of being exposed toward the parallelly arrayed direction.

In accordance with the receptacle connector according to the first aspect of the present invention, the extension terminal embedding portion is provided on at least one of the side portions of the connector body in the parallelly arrayed direction of the parallel terminals, and the extension terminal is embedded in the extension terminal embedding portion in the state of being exposed toward the parallelly arrayed direction, whereby the number of terminals can be increased at least by one. Therefore, the capacity of the signal to be transmitted can be increased. Moreover, the extension terminal is embedded in at least one of the side portions in the parallelly arrayed direction of the parallel terminals, and accordingly, the size of the connector itself is not increased, and the number of terminals can be increased in the same size as heretofore.

In the receptacle connector according to the first aspect of the present invention, preferably, the extension terminal embedding portion is provided on each of the side portions, respectively, and the extension terminal is embedded in each extension terminal embedding portion, respectively.

With such a configuration, the number of extension terminals can be set at two, and accordingly, the number of terminals can be increased more.

In this case, preferably, the parallel terminals and the extension terminals are individually connected to terminals on the counterpart connector, and transmit a high-speed serial signal thereto.

With such a configuration, a signal with a large capacity can be transmitted at a high speed.

In the receptacle connector according to the first aspect of the present invention, preferably, the counterpart connector insertion hood is fittable to a conventional Micro-USB type plug.

With such a configuration, the receptacle connector can be fitted to the conventional Micro-USB type plug already used in general, and accordingly, versatility thereof is enhanced.

In the receptacle connector according to the first aspect of the present invention, preferably, a board connection terminal portion is provided in each of the parallel terminals, the board connection terminal portion being to be connected onto a board on an instrument in a state where the connector body is provided on the instrument.

With such a configuration, the board connection terminal portion as so-called surface mount terminal to be directly connected onto the board of the instrument is provided, and accordingly, mountability of the receptacle connector on the board of the instrument is enhanced.

A plug according to a second aspect of the present invention is a plug to be fitted to the receptacle connector according to the first aspect of the present invention, the plug including: a housing having a fitting recessed portion to which the connector body is fittable; a counterpart parallel terminal support surface that is provided on an inner wall of the fitting recessed portion and supports five of counterpart parallel terminals in a parallelly arrayed state, the counterpart parallel terminals being brought into contact with and connected to the parallel terminals of the connector body fitted to the fitting recessed portion; and counterpart extension terminal support surface that supports a counterpart extension terminal brought into contact with and connected to the extension terminal of the connector body.

In accordance with the plug according to the second aspect of the present invention, the plug concerned is fitted to the receptacle connector according to the first aspect of the present invention, whereby the capacity of the signal to be transmitted can be increased. Moreover, the counterpart extension terminal is supported by the counterpart extension terminal support surface and accordingly, the size of the connector itself is not increased, and the number of terminals can be increased in the same size as heretofore.

In the plug according to the second aspect of the present invention, preferably, deflection notched spaces in which the counterpart parallel terminals and the counterpart extension terminal are deflectable are individually provided on an inner wall of the fitting recessed portion of the housing.

With such a configuration, the parallel terminals can be surely connected to the counterpart parallel terminals, and the extension terminal can be surely connected to the counterpart extension terminal.

In the plug according to the second aspect of the present invention, preferably, an instrument connection terminal portion is provided in the counterpart parallel terminal, the instrument connection terminal portion being to be connected to an instrument in a state where the housing is provided on the instrument.

With such a configuration, mountability of the plug on the instrument is enhanced.

### BRIEF DESCRIPTION OF THE DRAWINGS

FIG. 1 is a perspective view illustrating a front of a receptacle connector according to an embodiment of the present invention.

FIG. 2 is a perspective view illustrating a rear of the receptacle connector according to the embodiment.

FIG. 3 is a perspective view illustrating parallel terminals and extension terminals, which are embedded in the receptacle connector according to the embodiment.

FIG. 4 is a perspective view illustrating a front of a plug connector fittable to the receptacle connector according to the embodiment.

FIG. 5 is a perspective view illustrating counterpart parallel terminals and counterpart extension terminals, which are embedded in the plug connector fittable to the receptacle connector according to the embodiment.

FIG. 6 is a cross-sectional view illustrating the receptacle connector and the plug connector to be fitted to the receptacle connector according to the embodiment, illustrating a state before both thereof are fitted to each other.

### DESCRIPTION OF THE EMBODIMENTS

A description is made below of a receptacle connector and a plug to be fitted to the receptacle connector according to an embodiment of the present invention by using the drawings. The receptacle connector and the plug to be fitted to the receptacle connector, both of which are described below, are formed based on the Micro-USB standard, and dimensions, plate thicknesses, and the like thereof entirely conform to the dimensions, the plate thicknesses, and the like, which are defined in the Micro-USB standard.

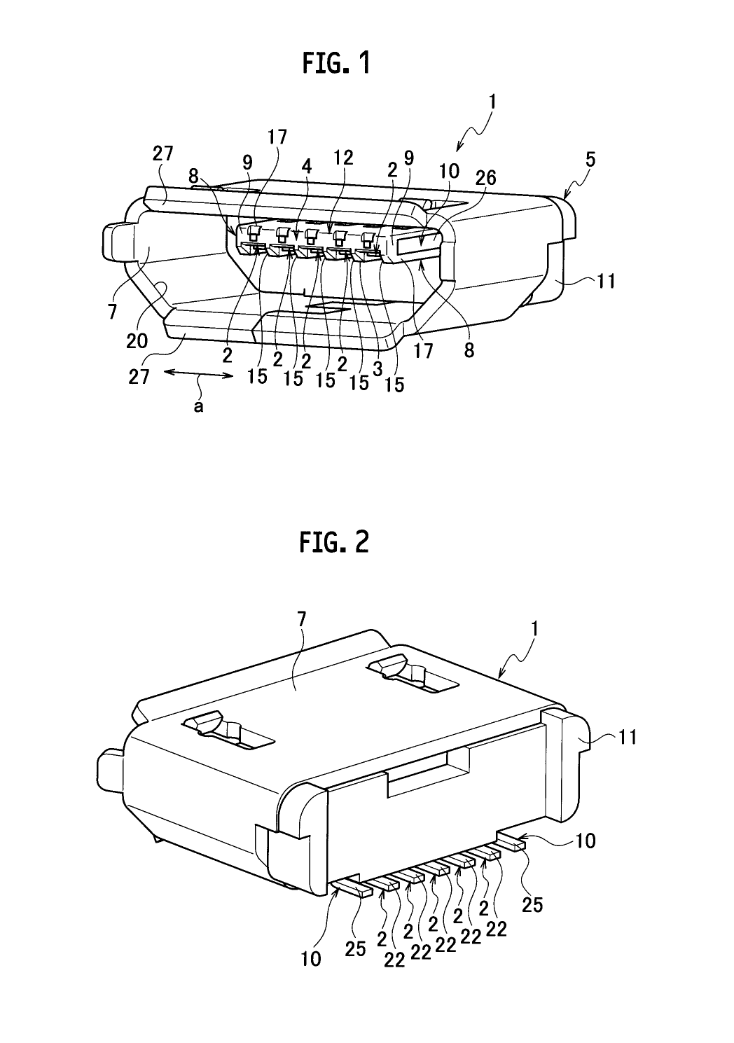

As illustrated in FIG. 1, a receptacle connector 1 according to the embodiment includes: a connector body 5 in which five of long-plate like parallel terminals 2 are embedded in a parallel terminal embedding portion 4 in a state of individually exposing one surface 3 of each of the parallel terminals 2; and a counterpart connector insertion hood 7 that covers an outer circumference side of the connector body 5 and allows a counterpart connector 31 (refer to FIG. 4) to be inserted thereinto.

The receptacle connector 1 further includes: an extension terminal embedding portion 9 provided on at least one of a pair of side portions 8 of the connector body 5 in a parallelly arrayed direction “a” of the parallel terminals 2; and at least one of extension terminal 10 embedded in the extension terminal embedding portion 9 in a state of being exposed toward the parallelly arrayed direction “a”. In the receptacle connector 1 according to the present embodiment, a description is made of the case where such extension terminal embedding portions 9 are provided on both of the side portions 8 and 8 in the parallelly arrayed direction of the parallel terminals 2, and such extension terminals 10 and 10 are embedded in the respective side portions 8 and 8.

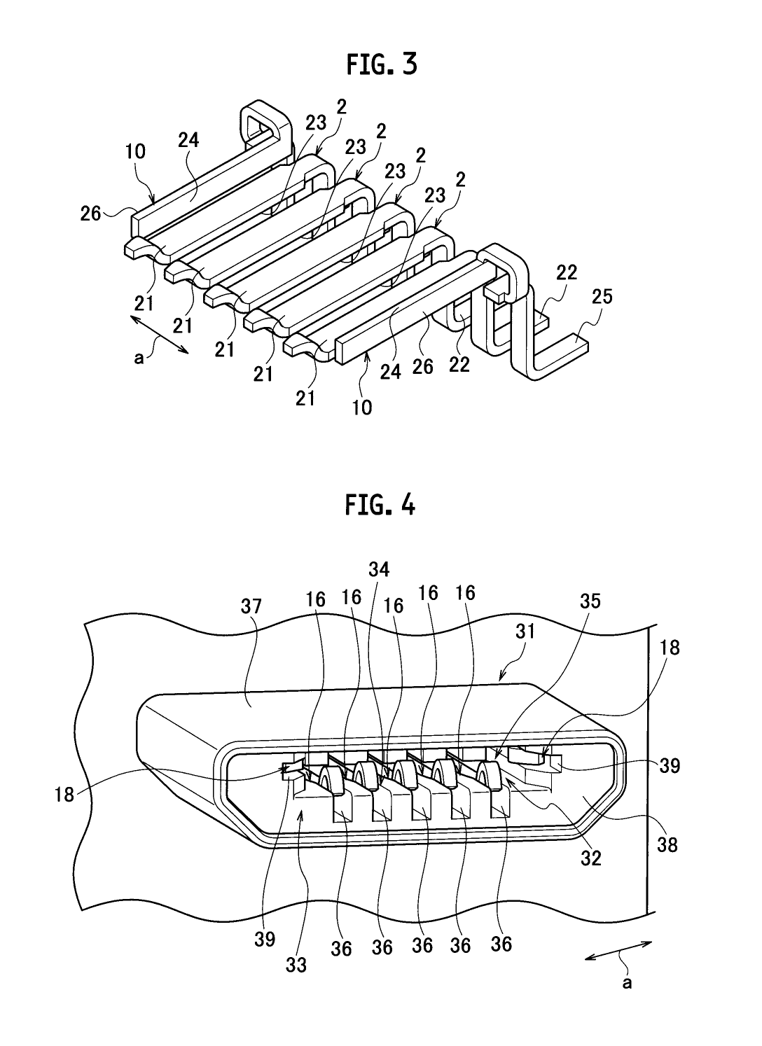

As illustrated in FIGS. 1, 2 and 6, the connector body 5 is formed of: a base 11: and a plate-like connection plate 12 protrudingly molded integrally with the base 11. In the base 11, intermediate portions of the parallel terminals 2 (refer to FIG. 3) to be described later are embedded. In the connection plate 12, connection terminal portion 21 of each of the parallel terminals 2 is embedded. In the connection plate 12, there are provided: the parallel terminal embedding portion 4 in which the parallel terminals 2 are embedded; and the extension terminal embedding portions 9 in which the extension terminals 10 are embedded.

On the parallel terminal embedding portion 4, five connection grooves 15 are provided in parallel from the base 11 side toward a tip end side of the connector body 5. On each of the connection grooves 15, a connection surface (one surface) 3 of each of the embedded parallel terminals 2 is exposed. Five of the parallel terminals 2 embedded in the connection plate 12 are embedded therein in a parallelly arrayed state. Counterpart parallel terminals 16 of a counterpart connector (a plug 31 to be described later) are individually inserted into the connection grooves 15, whereby the parallel terminals 2 are electrically connected to the counterpart parallel terminals 16.

The extension terminal embedding portions 9 are provided on both sides in the parallelly arrayed direction “a” of the parallel terminals 2, that is, on both sidewalls 17 of the connection plate 12. In the extension terminal embedding portions 9, the extension terminals 10 to be described later are individually embedded. One surface of each of the extension terminals 10 is exposed to an outside in the parallelly arrayed direction “a” of the parallel terminals 2 (that is, to the sidewall 17 side of the connection plate 12). On one surface of each of the extension terminals 10 exposed, counterpart extension terminals 18 of the counterpart connector contact the extension terminals 10 from the parallelly arrayed direction “a” of the parallel terminals 2, whereby the extension terminals 10 are connected to the counterpart extension terminals 18.

Such exposed portions of five of the parallel terminals 2 embedded in the parallel terminal embedding portion 4 and such exposed portions of two of the extension terminals 10 embedded in the extension terminal embedding portions 9 become fitting/contact surfaces.

The extension terminals 10 in such a state of being embedded in the extension terminal embedding portions 9 and allowing the one-side surfaces thereof to be exposed may be embedded while being exposed in a state of being flush with the sidewalls 17 of the connection plate 12, or may be embedded while being exposed in a state of recessing inward from the sidewalls 17 of the connection plate 12, or may be exposed in a state of protruding from the sidewalls 17 of the connection plate 12. In the case of exposing the extension terminals 10 in the state of recessing inward from the sidewalls 17 of the connection plate 12, contact positions of the extension terminals 10 with the counterpart extension terminals 18 are located inside of the connection plate 12, and accordingly, a gap between a periphery of the connection plate 12 and the counterpart connector insertion hood 7 can be utilized effectively.

As illustrated in FIGS. 1, 2 and 6, the counterpart connector insertion hood 7 is tubular. A one-side opening end 19 of the counterpart connector insertion hood 7 is fixed to the base 11 of the connector body 5, and the counterpart connector insertion hood 7 is assembled integrally with the base 11 so as to cover the periphery of the connection plate 12. On the other-side opening end 20 of the counterpart connector insertion hood 7, guides 27 and 27 which guide the counterpart connector (the plug 31 to be described later) to the inside thereof are provided. The counterpart connector is inserted/fitted to the inside of the counterpart connector insertion hood 7 from the other-side opening end 20. Then, the parallel terminals 2 are connected to the counterpart parallel terminals 16 of the counterpart connector. Moreover, the extension terminals 10 are connected to the counterpart extension terminals 18 of the counterpart connector.

As illustrated in FIGS. 2 and 3, each of the parallel terminals 2 has a long plate shape, and is formed in such a manner that an intermediate portion is bent in a crank shape. On one end side of each of the parallel terminals 2, the connection terminal portion 21 is provided. On the other end side of each of the parallel terminals 2, board connection terminal portion 22 is formed. One surface 23 of the connection terminal portion 21 is exposed to the connection groove 15 side in a state of being embedded in the connection plate 12. The exposed one surface 23 each becomes the fitting/contact surface. The board connection terminal portion 22 is formed substantially parallel to the connection terminal portion 21. The board connection terminal portion 22 becomes a surface mount terminal to be directly connected onto a board on an instrument (not illustrated) on which the receptacle connector 1 is to be mounted.

Each of the extension terminals 10 has a long stick shape, and is formed in such a manner that an intermediate portion thereof is bent in a crank shape in a similar way to each of the parallel terminals 2. On one end side of each of the extension terminals 10, a connection terminal portion 24 is provided. On the other end side of each of the extension terminals 10, a board connection terminal portion 25 is formed. One surface 26 of the connection terminal portion 24 is exposed in a state of being embedded in the connection plate 12. The exposed one surface 26 becomes the fitting/contact surface. The board connection terminal portion 25 allows an intermediate portion thereof to be bent, and is formed substantially parallel to the connection terminal portion 24. The board connection terminal portion 25 becomes a surface mount terminal to be directly connected onto the board on the instrument (not illustrated) on which the receptacle connector 1 is to be mounted.

Next, a description is made of the plug 31 as the counterpart connector to be fitted to the above-described receptacle connector 1.

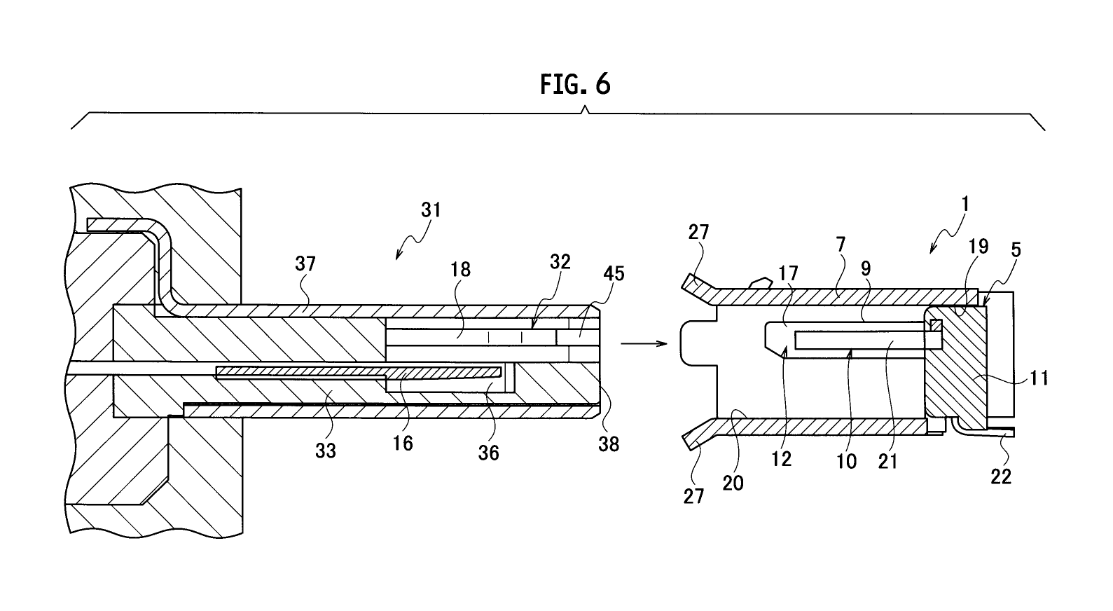

As illustrated in FIGS. 4 and 6, the plug 31 to be fitted to the receptacle connector 1 includes: a housing 33; a counterpart parallel terminal support surface 34; and counterpart extension terminal support surfaces 35. The housing 33 has a fitting recessed portion 32 to which the connector body 5 is fittable. The counterpart parallel terminal support surface 34 is provided on an inner wall of the fitting recessed portion 32, and supports five of the counterpart parallel terminals 16 in a parallelly arrayed state. Five of the counterpart parallel terminals 16 are brought into contact with and connected to five of the parallel terminals 2 of the connector body 5 fitted to the fitting recessed portion 32. The counterpart extension terminal support surfaces 35 support the counterpart extension terminals 18. The counterpart extension terminals 18 are brought into contact with and connected to the extension terminals 10 of the connector body 5. On the inner wall of the fitting recessed portion 32, there are provided: five of deflection notched spaces 36 in which the counterpart parallel terminals 16 are individually deflectable; and two of deflection notched spaces 39 in which the counterpart extension terminals 18 are individually deflectable.

The housing 33 is formed of a flat block that is made of synthetic resin and has insulation properties. An outer circumferential portion of the housing 33 is covered with a metal-made cover 37. An outer shape of the housing 33 covered with the cover 37 is formed into a shape fittable to the counterpart connector insertion hood 7 of the receptacle connector 1. The fitting recessed portion 32 is formed along a longitudinal direction of the housing 33. The connection plate 12 of the receptacle connector 1 is inserted and fitted into an inside of the fitting recessed portion 32. Then, the parallel terminals 2 embedded in the connection plate 12 are brought into elastically contact with and electrically connected to the counterpart parallel terminals 16 supported on the counterpart parallel terminal support surface 34 of the fitting recessed portion 32. Moreover, the extension terminals 10 are brought into elastically contact with and electrically connected to the counterpart extension terminals 18 supported on the counterpart extension terminal support surfaces 35.

The deflection notched spaces 36 provided on the counterpart parallel terminal support surface 34 are open toward an end surface 38 side of the housing 33 and the inside of the fitting recessed portion 32 thereof. The counterpart parallel terminals 16 embedded and supported in an inner side of the fitting recessed portion 32 are individually housed in the deflection notched spaces 36. The counterpart extension terminal support surfaces 35 are provided on both inner walls in the longitudinal direction (parallelly arrayed direction “a”) of the fitting recessed portion 32.

The deflection notched spaces 39 provided on the counterpart extension terminal support surfaces 35 are open toward the end surface 38 side of the housing 33 and the inside of the fitting recessed portion 32 thereof. The counterpart extension terminals 18 embedded and supported in the inner side of the fitting recessed portion 32 are individually housed in the deflection notched spaces 39.

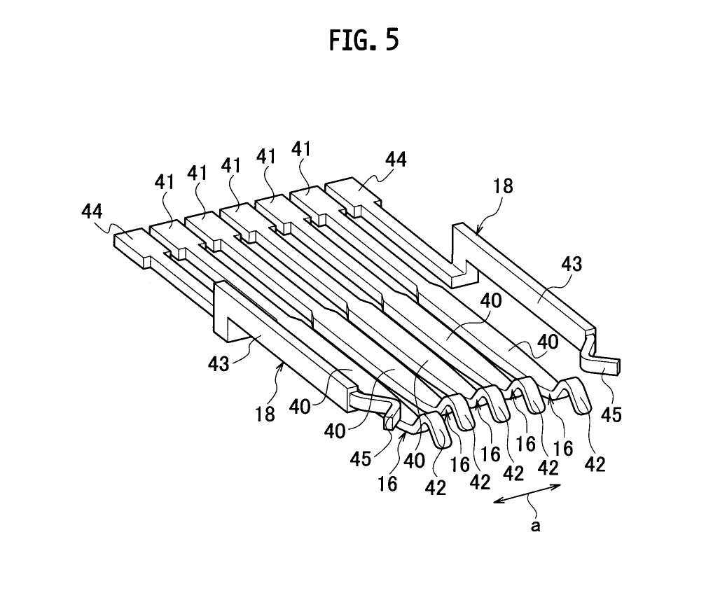

As illustrated in FIG. 5, each of the counterpart parallel terminals 16 has a long plate shape. On one end side of each of the counterpart parallel terminals 16, a connection terminal portion 40 is provided. On the other end side of each of the counterpart parallel terminals 16, an instrument connection terminal portion 41 is formed. On tip end side of the connection terminal portion 40, a bent contact portion 42 is formed. The bent contact portion 42 becomes a contact portion with corresponding parallel terminal 2 of the receptacle connector 1. On rear end side of the connection terminal portions 40, the instrument connection terminal portions 41 is formed. The instrument connection terminal portion 41 becomes a surface mount terminal to be directly connected onto a board on an instrument (not illustrated) on which the plug 31 is to be mounted.

Each of the counterpart extension terminals 18 has a long stick shape. On one end side of each of the counterpart extension terminals 18, a connection terminal portion 43 is provided. On the other end side of each of the counterpart extension terminals 18, a bent contact portion 45 is formed. The bent contact portion 45 becomes a contact portion with corresponding extension terminal 10 of the receptacle connector 1. On rear end side of the connection terminal portion 43, an instrument connection terminal portion 44 is formed. The instrument connection terminal portion 44 becomes a surface mount terminal to be directly connected onto the board on the instrument (not illustrated) on which the plug 31 is to be mounted.

In order to fit the plug 31 to the receptacle connector 1, as illustrated in FIG. 6, in a state where the housing 33 and the counterpart connector insertion hood 7 are positionally aligned with each other so that the connection plate 12 of the receptacle connector 1 can be inserted into the fitting recessed portion 32 of the plug 31, the housing 33 is inserted into the counterpart connector insertion hood 7. A shape of the counterpart connector insertion hood 7 is formed following the shape of the housing 33, and is formed a little larger than the housing 33. Therefore, the housing 33 is fitted to the inside of the counterpart connector insertion hood 7 only at a position where the connection plate 12 is insertable into the fitting recessed portion 32.

When the housing 33 is inserted into the inside of the counterpart connector insertion hood 7, the connection plate 12 is inserted into the fitting recessed portion 32. Then, each of the parallel terminals 2 of the connection plate 12 abuts against corresponding bent contact portion 42 of the counterpart parallel terminals 16 in the fitting recessed portion 32, and each of the extension terminals 10 of the connection plate 12 abuts against corresponding bent contact portion 45 of the counterpart extension terminals 18 in the fitting recessed portion 32. Moreover, the counterpart parallel terminals 16 are deflected in the deflection notched spaces 36 provided on the counterpart parallel terminal support surface 34, and the counterpart extension terminals 18 are deflected in the deflection notched spaces 39 provided on the counterpart extension terminal support surfaces 35. When the housing 33 is inserted into the counterpart connector insertion hood 7 in this state, the counterpart parallel terminals 16 in the fitting recessed portion 32 slide on the parallel terminals 2 in the connection plate 12, and the counterpart extension terminals 18 in the fitting recessed portion 32 slide on the extension terminals 10 in the connection plate 12. When the housing 33 is completely inserted into the counterpart connector insertion hood 7, the parallel terminals 2 are connected to the counterpart parallel terminals 16, and the extension terminals 10 are connected to the counterpart extension terminals 18.

In the case of fitting, to the receptacle connector 1, a general plug formed based on a Micro-USB standard instead of the plug 31, the counterpart extension terminals are not provided in the general plug, but the counterpart parallel terminals 16 are only provided therein, and accordingly, the extension terminals 10 are not used.

As described above, in accordance with the receptacle connector 1 according to the embodiment, the extension terminal embedding portion 9 is provided on at least one of the pair of side portions 8 of the connector body 5 in the parallelly arrayed direction “a” of the parallel terminals 2, and at least one of extension terminal 10 is embedded in the extension terminal embedding portion 9 in the state of being exposed toward the parallelly arrayed direction “a”. Therefore, the number of terminals can be increased at least by one, and accordingly, the capacity of the signal to be transmitted can be increased. Moreover, the extension terminal 10 is embedded in at least one of the pair of side portions 8 in the parallelly arrayed direction “a” of the parallel terminals 2, and accordingly, the size of the connector itself is not increased, and the number of terminals can be increased in the same size as heretofore based on the Micro-USB standard.

Moreover, extension terminal embedding portions 9 are provided on both of the side portions 8 in the parallelly arrayed direction “a” of the parallel terminals 2, and extension terminals 10 are individually embedded therein, whereby the number of extension terminals 10 is set at two, whereby the number of extension terminals 10 can be increased more.

Moreover, the parallel terminals 2 and the extension terminals 10 are connected to the counterpart parallel terminals 16 and the counterpart extension terminals 18 on the counterpart connector (plug 31), respectively, can thereby transmit a high-speed serial signal thereto, and can transmit a large-capacity signal thereto at a high speed.

Moreover, the receptacle connector 1 is fittable to the Micro-USB type plug, and can be thereby fitted to a Micro-USB plug that is already used in general. Therefore, versatility of the receptacle connector 1 is enhanced.

Moreover, in the parallel terminals 2, in the state where the connector body 5 is provided on the instrument, each board connection terminal portion 22 is provided as the so-called surface mount terminal to be directly connected onto the board of the instrument. Therefore, mountability of the receptacle connector 1 instrument onto the board is enhanced.

The plug 31 according to the embodiment includes: the housing 33 having the fitting recessed portion 32 to which the connector body 5 is fittable; the counterpart parallel terminal support surface 34 which is provided on the inner wall of the fitting recessed portion 32 and supports five of the counterpart parallel terminals 16 in the parallelly arrayed state, the counterpart parallel terminals 16 being brought into contact with and connected to the parallel terminals 2 of the connector body 5 fitted to the fitting recessed portion 32; and the counterpart extension terminal support surfaces 35 on which the counterpart extension terminals 18 are supported, the counterpart extension terminals 18 being brought into contact with and connected to the extension terminals 10 of the connector body 5. Therefore, the plug 31 is fitted to the receptacle connector 1, whereby the capacity of the signal to be transmitted can be increased.

Moreover, in the plug 31, the counterpart extension terminals 18 are supported by the counterpart extension terminal support surfaces 35 and accordingly, the size of the plug itself is not increased. Therefore, in the plug 31, with the same size as that of the conventional Micro-USB type plug, the number of terminals can be increased more than in the conventional Micro-USB type plug.

Moreover, the deflection notched spaces 36 and 39 in which the counterpart parallel terminals 16 and the counterpart extension terminals 18 are deflectable are individually provided on the inner wall of the fitting recessed portion 32. Therefore, the parallel terminals 2 can be surely connected to the counterpart parallel terminals 16, and the extension terminals 10 can be surely connected to the counterpart extension terminals 18.

Furthermore, in each of the counterpart parallel terminals 16, the instrument connection terminal portion 41 to be connected to the instrument side in the state where the housing 33 is provided on the instrument, and accordingly, the mountability of the plug 31 on the instrument is enhanced.

Note that, in the above-described embodiment, the description has been made of the example where the counterpart connector insertion hood 7 is assembled integrally with the connector body 5; however, the counterpart connector insertion hood 7 may be provided on the instrument on which the receptacle connector 1 is to be mounted, or alternatively, such a counterpart connector insertion hood 7 as a separate body may be assembled and fixed to the instrument.

What is claimed is:

1. A receptacle connector comprising:
a connector body in which five of long plate-like parallel terminals are embedded in a parallel terminal embedding portion in a state of individually exposing one surface sides thereof;
a counterpart connector insertion hood that covers an outer circumference of the connector body and allows a counterpart connector to be inserted thereinto;
an extension terminal embedding portion provided on at least one of a pair of side portions of the connector body in a parallelly arrayed direction of the parallel terminals; and
an extension terminal embedded in the extension terminal embedding portion in a state of being exposed toward the parallelly arrayed direction.

2. The receptacle connector according to claim 1, wherein
the extension terminal embedding portion is provided on each of the side portions, respectively, and
the extension terminal is embedded in each extension terminal embedding portion, respectively.

3. The receptacle connector according to claim 2, wherein the parallel terminals and the extension terminals are individually connected to terminals on the counterpart connector, and transmit a high-speed serial signal thereto.

4. The receptacle connector according to claim 1, wherein the counterpart connector insertion hood is fittable to a conventional Micro-USB type plug.

5. The receptacle connector according to claim 1, wherein, a board connection terminal portion is provided in each of the parallel terminals, the board connection terminal portion being to be connected onto a board on an instrument in a state where the connector body is provided on the instrument.

6. A plug to be fitted to the receptacle connector according to claim 1, comprising:
a housing having a fitting recessed portion to which the connector body is fittable;
a counterpart parallel terminal support surface that is provided on an inner wall of the fitting recessed portion and supports five of counterpart parallel terminals in a parallelly arrayed state, the counterpart parallel terminals being brought into contact with and connected to the parallel terminals of the connector body fitted to the fitting recessed portion; and
a counterpart extension terminal support surface that supports a counterpart extension terminal brought into contact with and connected to the extension terminal of the connector body.

7. The plug according to claim 6, wherein, deflection notched spaces in which the counterpart parallel terminals and the counterpart extension terminal are deflectable are individually provided on an inner wall of the fitting recessed portion of the housing.

8. The plug according to claim 6, wherein, an instrument connection terminal portion is provided in the counterpart parallel terminal, the instrument connection terminal portion being to be connected to an instrument in a state where the housing is provided on the instrument.
